(19) United States
(12) Patent Application Publication
(10) Pub. No.: US 2012/0172194 A1
(43) Pub. Date: Jul. 5, 2012

(54) DIELECTRIC CERAMIC AND METHOD OF MANUFACTURING THE SAME

(75) Inventors: Shang-hyeun PARK, Yongin-si (KR); Min-jong BAE, Yongin-si (KR); Tae-won JEONG, Yongin-si (KR); Sun-jin SONG, Suwon-si (KR)

(73) Assignee: SAMSUNG ELECTRONICS CO., LTD., Suwon-si (KR)

(21) Appl. No.: 13/327,187

(22) Filed: Dec. 15, 2011

(30) Foreign Application Priority Data
Dec. 30, 2010 (KR) 10-2010-0139339

(51) Int. Cl. C04B 35/622; C04B 35/468; C01F 11/02

(52) U.S. Cl. 501/137; 423/598

(57) ABSTRACT

A method for manufacturing a dielectric ceramic, the method including: combining a ferroelectric compound having a perovskite structure and a halide to provide a mixture; heat treating the mixture; and removing the halide from the heat treated mixture to manufacture the dielectric ceramic.

### CROSS-REFERENCE TO RELATED APPLICATIONS

This application claims priority to Korean Patent Application No. 10-2010-0139339, filed on Dec. 30, 2010, and all the benefits accruing therefrom under 35 U.S.C. §119, the content of which in its entirety is herein incorporated by reference.

### BACKGROUND

1. Field

The present disclosure relates to a dielectric ceramic and methods of manufacturing the same.

2. Description of the Related Art

Insulating materials having a high dielectric constant are widely used as interlayer dielectrics for condensers or capacitors of electric devices, communication devices, power devices, and inverters. They are also used as layer materials of piezoelectric elements, pyroelectric elements, and dielectrics for transfer body supports. Particularly, a dielectric plays an important role in determining the efficiency and brightness of inorganic electroluminescent (“EL”) devices. Further, use of an improved dielectric can provide an improved EL device having improved efficiency and brightness. When a dielectric has a high dielectric constant and a small loss tangent, the brightness and efficiency of an inorganic EL device may be considerably improved.

In addition, there are many other characteristics of insulating layers that are desirable for their use in each of the above-described devices because the performance of a final product is influenced by intermediate manufacturing processes. Also, the intrinsic properties of the dielectric material are also important because the performance of a final product depends on the selection of the dielectric material used as a starting material.

Accordingly, there remains a need for an improved dielectric material and methods for the manufacture thereof.

### SUMMARY

Provided is a method for manufacturing a dielectric ceramic having increased crystallinity and improved dielectric properties.

Provided is a dielectric ceramic having improved crystallinity and excellent dielectric properties.

Additional aspects, features, and advantages will be set forth in part in the description which follows and, in part, will be apparent from the description.

According to an aspect, disclosed is a method for manufacturing a dielectric ceramic. The method includes combining a ferroelectric compound having a perovskite structure and a halide to provide a mixture; heat treating the mixture; and removing the halide from the heat treated mixture to manufacture the dielectric ceramic.

According to an another aspect, provided is a dielectric ceramic including: a ferroelectric compound having a perovskite structure represented by the formula ABO₃, wherein A is at least one element selected from barium, lead, strontium, bismuth, calcium, magnesium, sodium, potassium, scandium, yttrium, lanthanum, cerium, praseodymium, neodymium, promethium, samarium, europium, gadolinium, terbium, dysprosium, holmium, erbium, thulium, ytterbium, and lutetium, B is at least one element selected from titanium, zirconium, niobium, tantalum, tungsten, manganese, iron, cobalt, nickel, chromium, and magnesium, and when analyzed by powder X-ray diffraction, the ferroelectric compound has a peak of highest intensity in an X-ray diffraction pattern at about 30.0° to about 35.0° two-theta, and a full width at half maximum of the peak of highest intensity is about 0.32° or less.

The method for manufacturing a dielectric ceramic may provide a dielectric ceramic having improved dielectric properties by reducing surface defects and increasing the crystallinity of the ferroelectric compound having a perovskite structure.

### BRIEF DESCRIPTION OF THE DRAWINGS

These and/or other aspects will become apparent and more readily appreciated from the following description of the embodiments, taken in conjunction with the accompanying drawings in which:

FIG. 1 is a perspective view illustrating an embodiment of the crystal structure of barium titanate (e.g., BaTiO₃), which is a representative example of a ferroelectric compound;

FIGS. 2A and 2B are graphs of intensity (counts) versus scattering angle (degrees two-theta, 2θ) showing the results of powder X-ray diffraction analysis before and after the heat treatment, respectively, for the BaTiO₃ dielectric ceramic manufactured according to Example 1;

FIGS. 3A and 3B are graphs of intensity (counts) versus scattering angle (degrees two-theta) showing the results of powder X-ray diffraction analysis before and after the heat treatment, respectively, for the BaTiO₃ dielectric ceramic manufactured according to Example 2;

FIGS. 4A and 4B are graphs of intensity (counts) versus scattering angle (degrees two-theta) showing the results of powder X-ray diffraction analysis before and after the heat treatment, respectively, for the BaTiO₃ dielectric ceramic manufactured according to Example 3;

FIG. 5 is a graph of intensity (counts) versus scattering angle (degrees two-theta) showing the results of powder X-ray diffraction analysis of the BaTiO₃ dielectric ceramic before heat treatment and manufactured according to Examples 7 to 9, and showing the change of the crystallinity of the BaTiO₃ dielectric ceramic according to the heat treatment temperature;

FIG. 6 is a scanning electron micrograph of the BaTiO₃ before the heat treatment in Example 3;

FIG. 7 is a scanning electron micrograph of the BaTiO₃ dielectric ceramic obtained after the heat treatment when using NaCl in Example 3; and

FIG. 8 is a scanning electron micrograph of the BaTiO₃ dielectric ceramic obtained after the heat treatment when using NaCl and InCl₃ in Example 4.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Also, these embodiments are provided so that this disclosure will be thorough and complete, and will fully convey the scope of the invention to those skilled in the art. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

A “halide” means a compound in which one of the elements is an element of Group 17 of the Periodic Table of the Elements.

A method for manufacturing a dielectric ceramic according to an embodiment provides a dielectric ceramic having improved dielectric properties. While not wanting to be bound by theory, it is believed that re-heat treatment of a ferroelectric compound in the presence of a halide as a flux reduces surface defects and increases the crystallinity of the ferroelectric compound. The dielectric ceramic can advantageously be used as a filler of a dielectric layer. When utilizing a dielectric layer of an inorganic electroluminescence (“EL”) device having the dielectric ceramic having increased crystallinity, a dielectric constant may be improved and a loss tangent reduced, and thus, the efficiency of the device may be increased.

The loss tangent is an index of the dielectric loss, and the factors determining the loss tangent include a loss due to ion migration, a loss due to oscillation and ion deformation, a loss due to electric polarization, a loss due to defects of materials, and a loss due to thermal expansion. The method for manufacturing a dielectric ceramic disclosed herein can substantially reduce or effectively eliminate defects of the dielectric material, which is understood to result in improved properties.

A method for manufacturing a dielectric ceramic according to an embodiment includes: combining a ferroelectric compound having a perovskite structure and a halide to provide a mixture; heat treating the mixture; and removing the halide, for example by washing the heat treated mixture, to manufacture the dielectric ceramic.

A ferroelectric compound, which is a raw material used for the manufacturing method, is a metal oxide having a perovskite structure. This ferroelectric compound comprises a first cation A, a second cation B, and three oxygen ions, and may be represented by the formula ABO₃, wherein A is at least one element selected from barium (Ba), lead (Pb), strontium (Sr), bismuth (Bi), calcium (Ca), magnesium (Mg), sodium (Na), potassium (K), and the rare-earth elements, which are scandium, yttrium, lanthanum, cerium, praseodymium, neodymium, promethium, samarium, europium, gadolinium, terbium, dysprosium, holmium, erbium, thulium, ytterbium, and lutetium, and B is at least one element selected from titanium (Ti), zirconium (Zr), niobium (Nb), tantalum (Ta), tungsten (W), manganese (Mn), iron (Fe), cobalt (Co), nickel (Ni), chromium (Cr), and magnesium (Mg).

In an embodiment A is at least one element selected from barium (Ba), lead (Pb), strontium (Sr), bismuth (Bi), calcium (Ca), magnesium (Mg), sodium (Na), and potassium (K). In another embodiment, A is barium. In an embodiment, B is at least one element selected from titanium (Ti), zirconium (Zr), and niobium (Nb). In another embodiment B is titanium. In still another embodiment, A is at least one element selected from barium (Ba), lead (Pb), strontium (Sr), bismuth (Bi), calcium (Ca), magnesium (Mg), sodium (Na), and potassium (K), and in addition, B is at least one element selected from titanium (Ti), zirconium (Zr), and niobium (Nb).

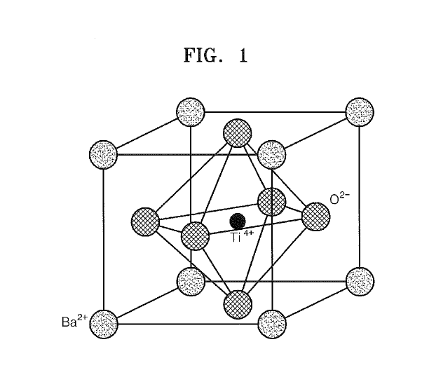

As a representative example of the structure of the ferroelectric compound, the crystal structure of barium titanate (e.g., BaTiO₃) is illustrated in FIG. 1. Referring to FIG. 1, Ba atoms are positioned at corners of a regular hexahedron, a Ti atom is positioned in the center of the regular hexahedron, and O atoms are positioned at centers of the faces of the regular hexahedron. In other words, the Ti atom is positioned in the center of a regular octahedron formed by oxygen atoms. At a temperature less than a phase transition temperature, the Ti atom and the Ba atoms move in a direction opposite to that of the oxygen atoms, so that a spontaneous polarization is formed, which results in ferroelectric properties.

The ferroelectric compound is not specifically limited to BaTiO₃ illustrated in FIG. 1. For example, a compound in which Ba is selected as an element in the A site, Ti is selected as an element in the B site, a portion of the Ba is substituted by another element, and/or a portion of the Ti is substituted by another element, may be used. For example, the ferroelectric compound may be a barium titanate perovskite compound represented by the formula Ba₁₋ₓA¹ₓTi_{1-y}B¹_{y}O₃, wherein A¹ is at least one element selected from Pb, Sr, Bi, Ca, Mg, Na, K, and rare-earth elements; B¹ is at least one element selected from Zr, Nb, Ta, W, Mn, Fe, Co, Ni, Cr, and Mg; and 0≦x<1 and 0≦y<1. The rare-earth elements are scandium, yttrium, lanthanum, cerium, praseodymium, neodymium, promethium, samarium, europium, gadolinium, terbium, dysprosium, holmium, erbium, thulium, ytterbium, and lutetium.

In another embodiment, the ferroelectric compound may be a barium titanate perovskite compound represented by the formula Ba₁₋ₓA¹ₓTi_{1-y}B¹_{y}O₃, wherein A¹ is at least one element selected from Pb, Sr, Bi, Ca, Mg, Na, and K; and B¹ is at least one element selected from Zr, Nb, Ta, W, Mn, Fe, Co, Ni, Cr, and Mg; and 0≦x≦1 and 0≦y<1.

Additional representative examples of the ferroelectric compound include calcium titanate (e.g., CaTiO₃), strontium titanate (e.g., SrTiO₃), barium zirconate (e.g., BaZrO₃), calcium zirconate (e.g., CaZrO₃), and the like. The foregoing compounds may also have a portion of the A and/or B elements substituted by a different A and/or B element. For example, Ca may be partially substituted with at least one element selected from Pb, Sr, Bi, Ba, Mg, Na, K, and rare-earth elements; and Ti may be partially substituted by at least one element selected from Zr, Nb, Ta, W, Mn, Fe, Co, Ni, Cr, and Mg.

In another embodiment, the ferroelectric compound may comprise a Pb perovskite compound such as lead magnesium niobate (e.g., Pb(Mg_{1/3}Nb_{2/3})O₃, “PMN”), lead nickel niobate (e.g., Pb(Ni_{1/3}Nb_{2/3})O₃, “PNN”), and lead zinc niobate (e.g., Pb(Zn_{1/3}Nb_{2/3})O₃, “PZN”).

The ferroelectric compound may be used alone or in a combination comprising at least one of the foregoing ferroelectric compounds.

The ferroelectric compound may be formed by a known manufacturing method, such as a hydrothermal synthesis method, a sol-gel method, or a solid state reaction method. The average particle size (e.g., average largest particle size) of the ferroelectric compound for manufacturing the dielectric ceramic is not specifically limited and the particle size may be selected according to the desired properties of the dielectric ceramic, for example a dielectric layer of a final product. For example, the average particle size of the ferroelectric compound starting material may be in the range of about 50 micrometers (μm) to about 500 μm, specifically in the range of about 100 μm to about 400 μm, and more specifically in the range of about 150 μm to about 300 μm.

First, in the manufacture the above-described dielectric ceramic, a combination, e.g., a mixture containing the ferroelectric compound and a halide is prepared to manufacture the above-described dielectric ceramic.

The halide may be at least one compound selected from a halide of an element of Group 1 to Group 13 of the Periodic Table of the Elements, and a halide of a Lanthanide element of the Periodic Table of the Elements, wherein the Lanthanide elements comprise the elements of atomic numbers 57 to 71, i.e., lanthanum, cerium, praseodymium, neodymium, promethium, samarium, europium, gadolinium, terbium, dysprosium, holmium, erbium, thulium, ytterbium, and lutetium. In another embodiment, the halide may be at least one selected from a halide of an element of Group 1 to Group 13. While not wanting to be bound by theory, it is believed that these halides can function as a flux in manufacture of the dielectric ceramic and they may be removed after the heat treatment by washing, for example, because they have a strong ionic bond. Also, the halide may be substantially or effectively inert to subsequent device manufacturing processes, and thus does not substantially interfere with other device manufacturing processes. Representative examples of the halide include sodium fluoride (NaF), sodium chloride (NaCl), magnesium fluoride (MgF₂), magnesium chloride (MgCl₂), calcium fluoride (CaF₂), calcium chloride (CaCl₂), strontium fluoride (SrF₂), strontium chloride (SrCl₂), barium fluoride (BaF₂), barium chloride (BaCl₂), aluminum fluoride (AlF₃), aluminum chloride (AlCl₃), indium fluoride (InF₃) indium chloride (InCl₃), scandium fluoride (ScF₂), scandium chloride (ScCl₂), yttrium fluoride (YF₃), yttrium chloride (YCl₃), lanthanum fluoride (LaF₃), lanthanum chloride (LaCl₃), cesium fluoride (CeF₃), cesium chloride (CeCl₃), ytterbium fluoride (YbF₃), ytterbium chloride (YbCl₃), niobium fluoride (NbF₃), niobium chloride (NbCl₃), samarium fluoride (SmF₃), samarium chloride (SmCl₃), europium fluoride (EuF₃), and europium chloride (EuCl₃), and the like. These may be used alone or in a combination comprising at least one of the foregoing. In an embodiment the halide is at least one selected from NaCl, InCl₃, NaF, and BaCl₂. According to an embodiment, NaCl may be used alone or in a combination comprising NaCl and InCl₃.

The halide is used in the mixture in an amount effective to produce the desired properties (e.g., improved crystallinity) in the dielectric ceramic after heat treating the mixture including the ferroelectric compound and the halide. In an embodiment, the halide is used in the mixture in an amount effective to act as a flux during the heat treatment of the mixture including the ferroelectric compound and the halide. For example, according to an embodiment, a volume ratio of the ferroelectric compound to the halide may be about 1:0.3 to about 1:3, specifically about 1:0.5 to about 1:2.5, more specifically about 1:1 to about 1:2. The volume ratio of the ferroelectric compound to the halide may be selected so that the halide has a sufficient effect as a flux, thereby improving the crystallinity of the ferroelectric compound.

According to an embodiment, the mixture may be obtained by wet-mixing the ferroelectric compound and the halide in a liquid. The liquid may fully or partially dissolve the ferroelectric compound and the halide, and may be selected from at least one of water, and an alcohol. Representative alcohols include at least one selected from primary and secondary linear aliphatic alcohols, such as methanol, n-propanol, isopropanol, n-butanol, sec-butanol, isobutanol, pentanol, hexanol, 2-ethylhexanol, tridecanol, and stearyl alcohol; cyclic alcohols such as cyclohexanol and cyclopheptanol; aromatic alcohols such as benzyl alcohol and 2-phenyl ethanol; polyhydric alcohols such as ethylene glycol, propylene glycol, 1,3-butanediol, 1,4-butanediol, 1,5-pentanediol, hexamethylene glycol, decamethylene glycol, 1,12-dihydroxyoctadecane, and glycerol; polymeric polyhydric alcohols such as polyvinyl alcohol; glycol ethers and polyalkylene glycol ethers such as methyl glycol, ethyl glycol, butyl glycol, diethylene glycol, triethylene glycol, tetraethylene glycol, higher polyethylene glycols, dipropylene glycol, tripropylene glycol, polypropylene glycol ether, and polybutylene glycol ether; aminated alcohols such as ethanolamine, propanolamine, isopropanolamine, hexanolamine, diethanolamine, diisopropanolamine, and dimethylethanolamine; and aminated polyhydric alcohols and glycol ethers such as aminated polyethylene glycol. These may be used alone or in a combination comprising at least one of the foregoing.

If the mixture is prepared by wet-mixing, the method may further include drying the mixture before heat treating the mixture.

When the wet-mixing is used, the combined materials (e.g., the ferroelectric compound and the halide) may be uniformly dispersed in the liquid, and when dried the halide may uniformly cover the primary particles of the ferroelectric compound. The drying may include evaporation of the liquid, e.g., the water or alcohol, and the drying of the mixture may be performed before the heat treatment. While not wanting to be bound by theory, it is believed that the halide may function as a flux when present on a surface of the primary particles of the ferroelectric compound in a subsequent heat treatment process, and the crystallinity of the particles may be uniformly improved.

According to an embodiment, with regard to a solvent used in the wet-mixing, for example, water, specifically deionized water, may be used as a solvent, and an alcohol such as ethanol, isopropyl alcohol, or the like, or a combination thereof, may be used as a solvent without any limit as long as the solvent is capable of dissolving the halide.

The drying of the mixture obtained by the wet-mixing may be performed at a temperature in the range of about 70° C. to about 200° C. According to an embodiment, the drying may be performed in a vacuum and at a temperature equal to or lower than about 100° C., and the pressure and temperature may be selected to provide a selected size of secondary particles and a sufficient drying. Specifically, the drying may be performed in a vacuum at a temperature in the range of about 60° C. to about 100° C., specifically at about 70° C. to about 90° C., more specifically at about 80° C. The drying may be performed for about 0.5 hour to about 5 hours, specifically about 1 hour to about 4 hours, more specifically about 1.5 hours to about 3 hours. Also, the drying may be performed at a pressure of about 1 Pascal (Pa) to about 100 kPa, specifically about 10 Pa to about 10 kPa, more specifically about 100 Pa to about 1 kPa. In another embodiment, the drying is performed at atmospheric pressure.

The mixture comprising the ferroelectric compound and the halide is heat-treated. In the heat treatment, and while not wanting to be bound by theory, the halide may function as a flux to provide primary particles of the ferroelectric compound having smoother shapes, and thus, the surface defects of the ferroelectric compound are reduced and the crystallinity thereof is increased.

According to an embodiment, the heat treatment may be performed at a temperature in a range equal to or greater than about 900° C. and less than about 1,300° C., specifically in the range of about 900° C. to about 1,100° C., more specifically about 1000° C.

When the ferroelectric compound is analyzed by powder X-ray diffraction after performing the heat treatment in the above-described range, the full width at half maximum of the peak of the highest intensity may be reduced, and thus the crystallinity of the ferroelectric compound may be improved. Particularly, in the case where the heat treatment is performed at a temperature in the range of about 900° C. to about 1,100° C., the full width at half maximum of the peak having the highest intensity may be reduced to be in a range of equal to or less than about 0.32°, specifically about 0.5° to about 0.3°, more specifically about 1° to about 2.5°. The heat treatment may be performed for about 10 minutes to about 2 hours, specifically about 20 minutes to about 1.5 hours, more specifically about 30 minutes to about 1 hours.

In addition, if the heat treatment is performed in a vacuum, the economics of the method may be improved because the luminosity of the surface of the ferroelectric compound may be preserved and the post-treatment may be partially or entirely omitted due to excellent surface characteristics of the ferroelectric compound provided by the drying process.

After the heat treatment, the halide is removed from the mixture, for example the mixture is washed to remove the halide. When washing the mixture, deionized water may be suitable to avoid contamination by a foreign material. In the washing, the halide contained in the mixture is removed, the crystallinity of the ferroelectric compound may be increased, and a dielectric ceramic having improved dielectric properties may be obtained.

The dielectric ceramic obtained by the above-described manufacturing method may comprise, and in an embodiment consists of, secondary particles each comprising, e.g., formed by aggregating, a plurality of primary particles of the ferroelectric compound, wherein the ferroelectric compound primary particles in the dielectric ceramic have rounder and smoother shapes than particles of the ferroelectric compound used as a starting material to form the mixture. While not wanting to be bound by theory, it is believed that the primary particles of the dielectric ceramic having rounder and smoother shapes and have fewer surface defects. In addition, as is shown in the following Examples, the dielectric ceramic disclosed herein has a higher level of crystallinity than the ferroelectric compound used as a starting material, thereby improving the dielectric constant and reducing the loss tangent of the dielectric ceramic.

The average primary particle size of the ferroelectric compound after the heat treatment may be in the range of about 5 micrometers (μm) to about 500 μm, specifically in the range of about 10 μm to about 400 μm, and more specifically in the range of about 50 μm to about 300 μm. The average secondary particle size of the dielectric ceramic (e.g., the ferroelectric compound) after heat treatment, wherein the secondary particle comprises a plurality of primary particles, may be in the range of about 10 micrometers (μm) to about 1000 μm, specifically in the range of about 50 μm to about 500 μm, and more specifically in the range of about 100 μm to about 300 μm.

The dielectric ceramic obtained by the manufacturing method disclosed herein does not substantially contain the halide because the halide is substantially or effectively removed. Herein, the recitation “the dielectric ceramic does not substantially contain the halide” means that an amount of the halide is equal to or less than about 1 weight percent (weight %), based on a total weight of the dielectric ceramic, specifically less than about 0.1 weight %. In an embodiment the dielectric ceramic does not contain the halide in a detectable amount. While not wanting to be bound by theory, it is believed that as long as the amount of the halide is in the range disclosed herein, the halide does not substantially or effectively affect the desirable properties of a final device formed using the dielectric ceramic. In an embodiment, the content of the halide in the dielectric ceramic is in the range of about 0.001 weight % to about 1 weight %, specifically about 0.005 weight % to about 0.5 weight %, more specifically about 0.01 weight % to about 0.1 weight %, based on a total weight of the dielectric ceramic.

A dielectric ceramic according to another embodiment will now be described.

The dielectric ceramic may comprise a ferroelectric compound having a perovskite structure represented by ABO₃, wherein A is at least one element selected from Ba, Pb, Sr, Bi, Ca, Mg, Na, K, and a rare-earth element, and B is at least one element selected from Ti, Zr, Nb, Ta, W, Mn, Fe, Co, Ni, Cr, and Mg, wherein when analyzed by powder X-ray diffraction, the ferroelectric compound has a peak of highest intensity at about 30.0° to about 35.0° two-theta (2θ), and a full width at half maximum of the peak of highest intensity is about 0.32° or less. In an embodiment the full width at half maximum may be about 0.5° to about 0.3°, specifically about 1° to about 2.5°. The rare-earth elements are scandium, yttrium, lanthanum, cerium, praseodymium, neodymium, promethium, samarium, europium, gadolinium, terbium, dysprosium, holmium, erbium, thulium, ytterbium, and lutetium.

The dielectric ceramic comprises, and in an embodiment consists of, secondary particles each comprising, e.g., formed by agglomerating, a plurality of primary particles, and may be manufactured by the manufacturing method disclosed herein. In an embodiment, the dielectric ceramic may be obtained using the ferroelectric compound as a starting material, heat treating the ferroelectric compound in the presence of the halide, and removing the halide. The dielectric ceramic disclosed herein comprises primary particles of the ferroelectric compound having a smoother shape, reduced surface defects, and a crystallinity higher than that of the ferroelectric compound starting material, which may be a ferroelectric compound manufactured by a known, e.g., a commercially available manufacturing method, such as by a hydrothermal synthesis method, a sol-gel method, or a solid state reaction method.

According to an embodiment, the ferroelectric compound may be represented by the formula Ba₁₋ₓA¹ₓTi_{1-y}B¹_{y}O₃, wherein A¹ is at least one element selected from Pb, Sr, Bi, Ca, Mg, Na, K, and a rare-earth element; B¹ is at least one element selected from Zr, Nb, Ta, W, Mn, Fe, Co, Ni, Cr, and Mg; and 0≦x<1 and 0≦y<1. In an embodiment, an embodiment, A¹ is at least one element selected from Pb, Sr, Bi, Ca, Mg, Na, and K. In another embodiment, the ferroelectric compound may be a barium titanate perovskite compound represented by the formula Ba₁₋ₓA¹ₓTi_{1-y}B¹_{y}O₃, wherein A¹ is at least one element selected from Pb, Sr, Bi, Ca, Mg, Na, and K; and B¹ is at least one element selected from Zr, Nb, Ta, W, Mn, Fe, Co, Ni, Cr, and Mg; and 0≦x<1 and 0≦y<1. In another embodiment, the ferroelectric compound is BaTiO₃.

When the dielectric ceramic is analyzed by powder X-ray diffraction, a diffraction peak having the highest intensity is in the range of at about 30.0° to about 35.0° two-theta (2θ), and the peak having the highest intensity has a full width at half maximum equal to or less than about 0.32°, specifically about 0.5° to about 0.3°, more specifically about 1° to about 2.5°. This full width at half maximum may be distinguished from that of the ferroelectric compound starting material, which may be manufactured by a commercially available manufacturing method, such as the hydrothermal synthesis method, the sol-gel method, or the solid state reaction method, wherein the corresponding full width at half maximum of the ferroelectric compound starting material may be larger than about 0.32°.

According to an embodiment, the dielectric ceramic may further comprise the halide, wherein the halide may be present as an impurity, for example. For example, the halide may be included in the dielectric ceramic, which comprises the secondary particles that each comprise, e.g., are formed by aggregating, a plurality of primary particles, in a form wherein the halide is disposed at interfaces between adjacent primary particles, wherein the interfaces are inside each secondary particle. Thus the dielectric ceramic may comprise secondary particles, and the secondary particles may comprise primary particles of the ferroelectric compound and the halide. Also, the halide may be between adjacent primary particles of the ferroelectric compound, and the halide may be directly on a surface of the primary particles of the ferroelectric compound.

The halide may be at least one selected from a halide of Group 1 to Group 13 of the Periodic Table of the Elements, and a halide a Lanthanide element of the Periodic Table of the Elements. Representative examples of the halide include, NaF, NaCl, MgF₂, MgCl₂, CaF₂, CaCl₂, SrF₂, SrCl₂, BaF₂, BaCl₂, AlF₃, AlCl₃, InF₃, InCl₃, ScF₂, ScCl₂, YF₃, YCl₃, LaF₃, LaCl₃, CeF₃, CeCl₃, YbF₃, YbCl₃, NbF₃, NbCl₃, SmF₃, SmCl₃, EuF₃, EuCl₃, or the like. These materials may be used alone or in a combination comprising at least one of the foregoing. According to an embodiment, the halide contained in the dielectric ceramic may be at least one selected from NaCl, InCl₃, NaF, and BaCl₂. In an embodiment, the halide is NaCl, or a mixture of NaCl and InCl₃.

The content of the halide in the dielectric ceramic may be equal to or less than about 1 weight %, less than about 0.1 weight %, specifically about 0.001 weight % to about 1 weight %, more specifically about 0.005 weight % to about 0.5 weight %, or about 0.01 weight % to about 0.1 weight %, based on a total weight of the dielectric ceramic.

Exemplary Examples will now be described. The scope of this disclosure shall not limited to the following exemplary Examples.

Manufacture of Dielectric Ceramic with NaCl

### EXAMPLES 1-3

BaTiO₃ having an average particle size of about 150 nanometers (nm) (Example 1), about 180 nm (Example 2), or about 300 nm (Example 3), respectively, and NaCl as a halide were combined in a volumetric ratio of 1:1 and mixed with deionized water. The mixture was dried at a temperature of about 80° C. for about 4 hours in a vacuum oven. The dried mixture was heat-treated at a temperature of about 1,000° C. for about 30 minutes in a vacuum furnace. After the heat-treating, the mixture of BaTiO₃ and NaCl was washed with deionized water to remove NaCl, and then pulverized in a ball mill to manufacture the BaTiO₃ dielectric ceramic having increased crystallinity.

### EXAMPLES 4-6

### Manufacture of Dielectric Ceramic with InCl₃

BaTiO₃ dielectric ceramic was manufactured according to the same method as in Examples 1 to 3, respectively, except that a mixture of NaCl and InCl₃ in a volumetric ratio of 1:1 was used as a flux.

### EXAMPLES 7-9 AND COMPARATIVE EXAMPLE 1

### Manufacture of Dielectric Ceramic at Various Heat Treatment Temperatures

BaTiO₃ having an average particle size of about 300 nm and NaCl as a halide were combined in a volumetric ratio of 1:1 and mixed with deionized water.

The mixture was dried at a temperature of about 80° C. for about 4 hours in a vacuum oven. The dried mixture was heat-treated at a temperature of about 700° C. (Example 7), about 900° C. (Example 8), about 1,100° C. (Example 9), and about 1,300° C. (Comparative Example 1), respectively, for about 30 minutes in a vacuum furnace. After the heat-treating, the mixture of BaTiO₃ and NaCl was washed with deionized water to remove NaCl and then pulverized in a ball mill to manufacture the BaTiO₃ dielectric ceramic having an increased crystallinity.

### Measurement of Properties of Dielectric Ceramic

### EVALUATION EXAMPLE 1

### Measurement of X-Ray Diffraction

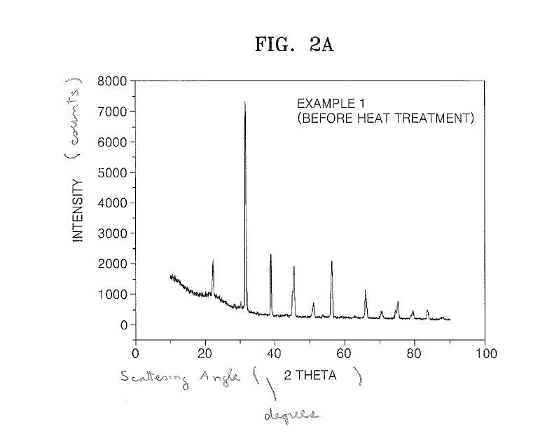

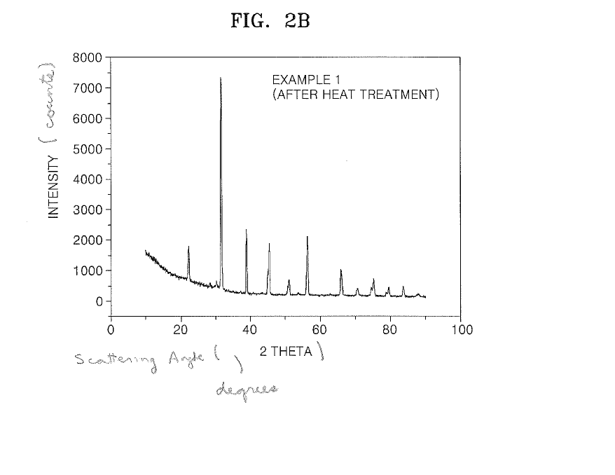

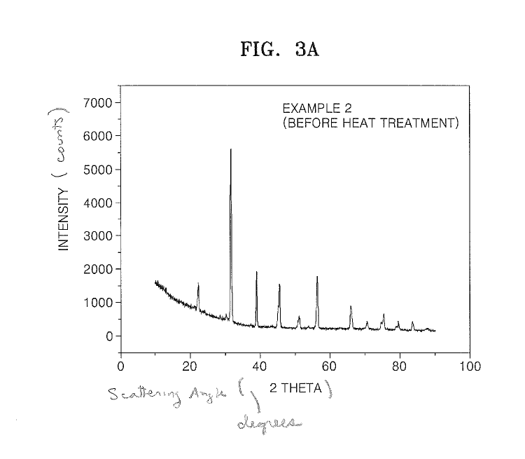

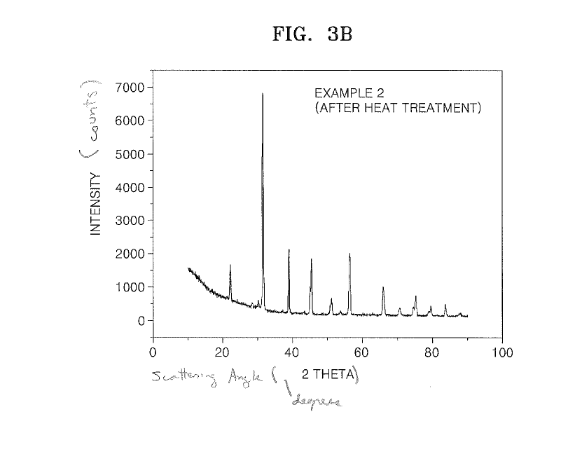

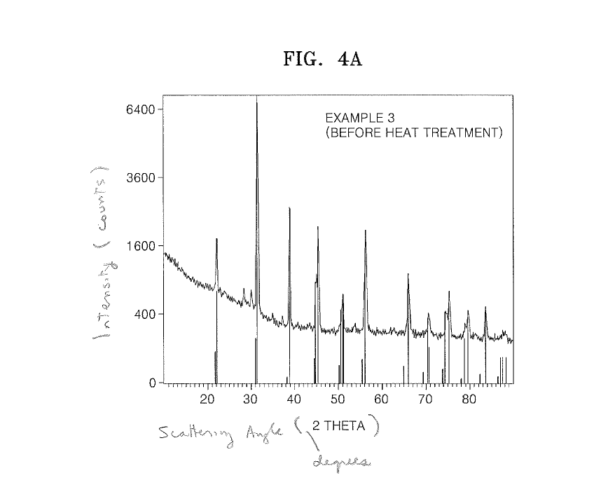

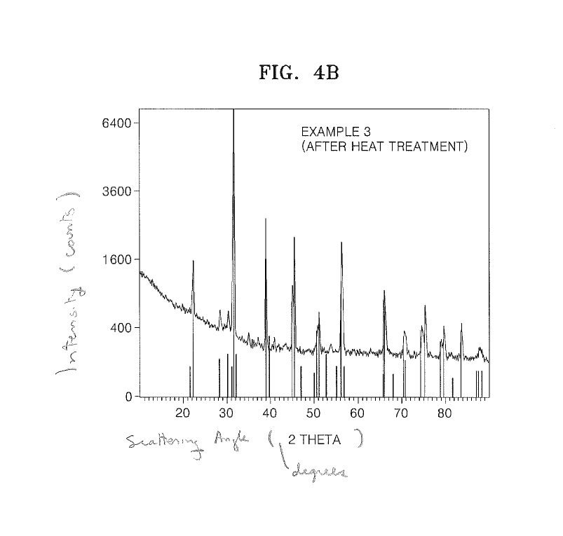

The X-ray diffraction patterns before and after the heat treatment of the BaTiO₃ dielectric ceramic manufactured in the Examples 1 to 3 were measured and the results are illustrated in FIGS. 2a to 4b. In the X-ray diffraction patterns in FIGS. 2a to 4b, the peaks showing the highest intensity were detected at about 30.0° to about 35.0° two-theta (2θ), and the full widths at half maximum (“FWHM”) of the peak of highest intensity at about 30.0° to about 35.0° before and after the heat treatment was measured, and the results are listed in following Table 1.

TABLE 1

| | Before the heat treatment | After the heat treatment |
|---|---|---|
| | (FWHM, °2θ) | (FWHM, °2θ) |
| Example 1 | 0.3239 | 0.3073 |
| Example 2 | 0.3286 | 0.3169 |
| Example 3 | 0.3201 | 0.3128 |

As shown in Table 1, the BaTiO₃ dielectric ceramics of the Examples 1 to 3 have a reduced full width at half maximum after the heat treatment and the FWHMs after heat treatment are equal to or lower than about 0.32°. While not wanting to be bound by theory, it is understood that the reduced FWHM confirms the increase of the crystallinity.

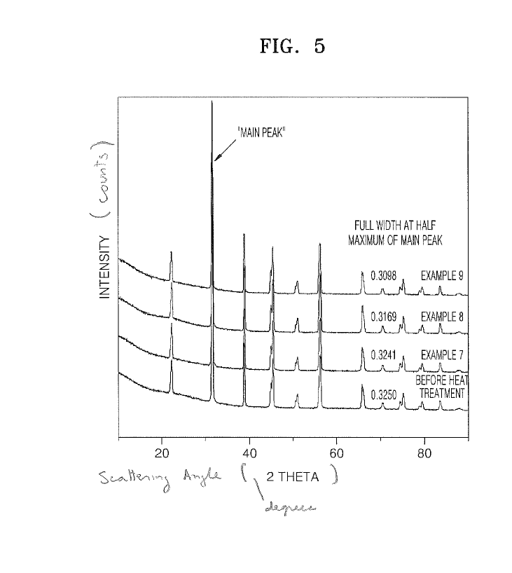

In addition, to verify the effect of heat treatment temperature on the crystallinity of the BaTiO₃ dielectric ceramic, the X-ray diffraction patterns of the BaTiO₃ crystals before the heat treatment and those of the BaTiO₃ dielectric ceramic obtained from the Examples 7 to 9 and Comparative Example 1 before and after the heat treatment were measured and the results are shown in FIG. 5 and summarized in Table 2.

TABLE 2

| | Heat Treatment | FWHM |
|---|---|---|
| | Temperature | (°2θ) |
| Before Heat Treatment | — | 0.3250 |
| Example 7 | 700° C. | 0.3241 |
| Example 8 | 900° C. | 0.3169 |
| Example 9 | 1,100° C. | 0.3098 |

As shown in FIG. 5 and summarized in Table 2, while the full width at half maximum of the main peak is 0.3250° before the heat treatment, when using the halide, and the higher the temperature of the heat treatment, such as about 700° C. (Example 7), about 900° C. (Example 8), and about 1,100° C. (Example 9), the greater the reduction in the full width at half maximum. Specifically, the full width at half maximum was reduced to 0.3241°, 0.3169°, and 0.3098°, respectively, and the intensity of the peak increased, and while not wanting to be bound by theory, the crystallinity is improved. Particularly, when the heat treatment temperature is equal to or higher than about 900° C., the full width at half maximum of the main peak is equal to or lower than about 0.32°, and very high crystallinity is provided. However, when the heat treatment temperature of the mixture is about 1,300° C., the aggregation is so severe that it is virtually impossible to measure the X-ray diffraction pattern, and thus, the result was not included in FIG. 5 or Table 2.

### EVALUATION EXAMPLE 2

### SEM Analysis

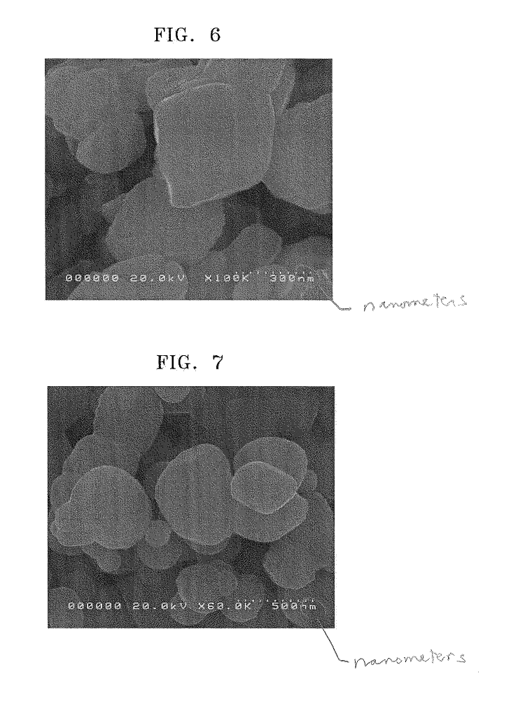

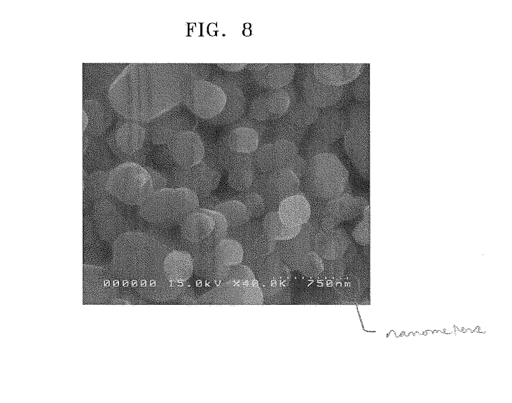

To analyze the forms of the particles of the BaTiO₃ dielectric ceramics, the BaTiO₃ dielectric ceramics manufactured in the Examples 3 to 6 were analyzed by the Scanning Electron Microscopy and the results are shown in FIGS. 6 to 8. FIG. 6 is a scanning electron micrograph (“SEM”) of the BaTiO₃ before the heat treatment, FIG. 7 is a SEM of the BaTiO₃ dielectric ceramic of Example 3 obtained after the heat treatment using NaCl as a halide, and FIG. 8 is a SEM of the BaTiO₃ dielectric ceramic of Example 4 obtained after the heat treatment using NaCl and InCl₃ as a halide.

As shown in FIGS. 6 to 8, the BaTiO₃ used as a starting material, i.e., before the heat treatment, has particles with angulated surfaces and the BaTiO₃ dielectric ceramic obtained in the Examples 3 and 4 has particles with smooth surfaces.

From the above result, it may be confirmed that the method for manufacturing a dielectric ceramic disclosed herein provides for a reduction of the surface defects of the ferroelectric compound and increases of the crystallinity of the material.

### EVALUATION EXAMPLE 3

### Component Analysis

According to the results of the component analysis of the BaTiO₃ dielectric ceramic manufactured in the Example 3 by Inductively Coupled Plasma-Atomic Emission Spectroscopy (“ICP-AES”), about 0.037 weight % of Na was detected. In addition, it was observed that Cl also exists in a certain amount corresponding to that of Na. This shows that the halide may not be completely removed by washing in the manufacturing process and a portion of the halide may remain as an impurity by being adhered to the primary particles of the BaTiO₃ dielectric ceramic.

### EVALUATION EXAMPLE 4

### Analysis of Dielectric Properties

A test device was manufactured as follows to analyze the dielectric properties of the dielectric ceramic manufactured in the Examples 1 to 3.

A dielectric paste was manufactured by sufficiently mixing about 6 grams (g) of the dielectric ceramic manufactured in the Examples 1 to 3, about 1.8 g of polyvinyl butyral, and about 8.2 g of DMF, and the dielectric paste was formed to have a selected thickness by spin coating in order to form a dielectric layer. The thicknesses of the dielectric layers are shown in the following Table 3. The test device was manufactured by depositing Al on a first side of the dielectric layer as an upper electrode and indium tin oxide (“ITO”) on an opposite second side thereof as a lower electrode.

To analyze the dielectric properties of the test device manufactured as above, the dielectric constant and the dielectric loss tan δ were measured at a frequency of about 1 kiloHertz (kHz) and at an electric potential of about 1 volt by using an inductance-capacitance-resistance (“LCR”) meter at a temperature in the range of about −55° C. to about 155° C., and the results are described in the following Table 3. For comparison purposes and to clarify the change of the dielectric constant and the dielectric loss, Comparative Examples 3 to 5 are test devices manufactured using the BaTiO₃ used as a starting material in Examples 1 to 3, respectively. In Table 3, nF refers to nanoFarads, eₒ refers to the electric constant, A refers to area, d refers to thickness, R_{pw} refers to resistance, Cₚ refers to capacitance using the product of the Example or Comparative Example, and Cₒ refers to a reference capacitance.

TABLE 3

| | | Electric | | | Dielectric | | |
|---|---|---|---|---|---|---|---|
| | Thickness | capacity | Resistance | | constant | | |
| | (μm) | (nF) | (kohm) | e₀A/d | Cₚ/C₀ | 1/R_{pw}C₀ | Tan δ |
| Comparative | 3.24 | 25.84 | 51.79 | 2.73E−10 | 94.60 | 11.2563 | 0.118988 |
| example 3 | | | | | | | |
| Example 1 | 3.3 | 28.35 | 82.27 | 2.68E−10 | 105.71 | 7.2172 | 0.068272 |
| Comparative | 3 | 27.27 | 80.56 | 2.95E−10 | 85.05 | 14.8946 | 0.175126 |
| example 4 | | | | | | | |
| Example 2 | 3 | 25.9 | 102.9 | 2.95E−10 | 92.44 | 6.7004 | 0.072483 |
| Comparative | 2.5 | 29.31 | 111.3 | 3.54E−10 | 71.44 | 4.3714 | 0.061189 |
| example 5 | | | | | | | |
| Example 3 | 2.7 | 29.31 | 111.3 | 32.8E−10 | 89.42 | 4.3648 | 0.048812 |

As shown in Table 3, it may be confirmed that the test devices manufactured using the dielectric ceramic of the Examples 1 to 3 have improved dielectric constants and reduced dielectric loss tan δs. While not wanting to be bound by theory, it is believed that this is because the defects of the BaTiO₃ dielectric ceramic are reduced as disclosed above.

As further described above, a dielectric ceramic, obtained by a method for manufacturing a dielectric ceramic using the halide and heat treating, has reduced defects and improved crystallinity. Therefore, when using the dielectric ceramic as a dielectric layer, the properties of a device including the dielectric layer may be improved. Particularly, when utilizing the dielectric ceramic in an inorganic EL device, the efficiency of the device may be increased by reducing the loss tangent value. Also, when the dielectric ceramic is utilized in other electronic devices as an insulating layer or a dielectric layer, the loss tangent provides an excellent assessment of properties at high frequency. Accordingly, the efficiency of numerous devices may be increased.

It should be understood that the exemplary embodiments disclosed herein should be considered in a descriptive sense only and not for purposes of limitation. Descriptions of features, advantages, or aspects within each embodiment should be considered as available for other similar features or aspects in other embodiments.

What is claimed is:

1. A method for manufacturing a dielectric ceramic, the method comprising:
combining a ferroelectric compound having a perovskite structure and a halide to provide a mixture;
heat treating the mixture; and
removing the halide from the heat treated mixture to manufacture the dielectric ceramic.

2. The method of claim 1, wherein the ferroelectric compound is represented by the formula ABO₃, wherein
A is at least one element selected from barium, lead, strontium, bismuth, calcium, magnesium, sodium, potassium, scandium, yttrium, lanthanum, cerium, praseodymium, neodymium, promethium, samarium, europium, gadolinium, terbium, dysprosium, holmium, erbium, thulium, ytterbium, and lutetium, and
B is at least one element selected from titanium, zirconium, niobium, tantalum, tungsten, manganese, iron, cobalt, nickel, chromium, and magnesium.

3. The method of claim 1, wherein the ferroelectric compound is represented by the formula Ba₁₋ₓA¹ₓTi_{1-y}B¹_{y}O₃, wherein A¹ is at least one element selected from lead, strontium, bismuth, calcium, magnesium, sodium, potassium, scandium, yttrium, lanthanum, cerium, praseodymium, neodymium, promethium, samarium, europium, gadolinium, terbium, dysprosium, holmium, erbium, thulium, ytterbium, and lutetium, and
B¹ is at least one element selected from zirconium, niobium, tantalum, tungsten, manganese, iron, cobalt, nickel, chromium, and magnesium, and
0≦x<1 and 0≦y<1.

4. The method of claim 1, wherein the ferroelectric compound is BaTiO₃.

5. The method of claim 1, wherein the average particle size of the ferroelectric compound is in the range of about 50 micrometers to about 500 micrometers.

6. The method of claim 1, wherein the halide is at least one selected from a halide of an element of Group 1 to Group 13 of the Periodic Table of the Elements, and a halide of a Lanthanide element of the Periodic Table of the Elements.

7. The method of claim 6, wherein the halide is at least one selected from sodium fluoride, sodium chloride, magnesium fluoride, magnesium chloride, calcium fluoride, calcium chloride, strontium fluoride, strontium chloride, barium fluoride, barium chloride, aluminum fluoride, aluminum chloride, indium fluoride, indium chloride, scandium fluoride, scandium chloride, yttrium fluoride, yttrium chloride, lanthanum fluoride, lanthanum chloride, cesium fluoride, cesium chloride, yttrium fluoride, ytterbium chloride, niobium fluoride, niobium chloride, samarium fluoride, samarium chloride, europium fluoride, and europium chloride.

8. The method of claim 7, wherein the halide is NaCl.

9. The method of claim 1, wherein the halide is a combination of NaCl and InCl₃.

10. The method of claim 1, wherein a ratio of the ferroelectric compound to the halide is about 1:0.3 to about 1:3, by volume.

11. The method of claim 1, wherein the mixture is obtained by wet-mixing the ferroelectric compound and the halide in a solvent comprising at least one selected from water and alcohol.

12. The method of claim 11, further comprising, drying the mixture before the heat treating.

13. The method of claim 12, wherein the drying is performed in a vacuum at a temperature equal to or less than about 100° C.

14. The method of claim 12, wherein the drying is performed at a temperature in the range of about 50° C. to about 100° C.

15. The method of claim 1, wherein the heat treatment is performed at a temperature equal to or greater than about 700° C. and less than about 1,300° C.

16. The method of claim 1, wherein the heat treatment is performed at a temperature in the range of about 900° C. to about 1,100° C.

17. The method of claim 1, wherein the heat treatment is performed in a vacuum.

18. A dielectric ceramic comprising:
a ferroelectric compound having a perovskite structure represented by the formula ABO₃, wherein
A is at least one element selected from barium, lead, strontium, bismuth, calcium, magnesium, sodium, potassium, scandium, yttrium, lanthanum, cerium, praseodymium, neodymium, promethium, samarium, europium, gadolinium, terbium, dysprosium, holmium, erbium, thulium, ytterbium, and lutetium,
B is at least one element selected from titanium, zirconium, niobium, tantalum, tungsten, manganese, iron, cobalt, nickel, chromium, and magnesium, and
when analyzed by powder X-ray diffraction, the ferroelectric compound has a peak of highest intensity at about 30.0° to about 35.0° two-theta, and a full width at half maximum of the peak of highest intensity is about 0.32° or less.

19. The dielectric ceramic of claim 18, wherein the ferroelectric compound is represented by the formula Ba₁₋ₓA¹ₓTi_{1-y}B¹_{y}O₃,
wherein
A¹ is at least one element selected from lead, strontium, bismuth, calcium, magnesium, sodium, potassium, scandium, yttrium, lanthanum, cerium, praseodymium, neodymium, promethium, samarium, europium, gadolinium, terbium, dysprosium, holmium, erbium, thulium, ytterbium, and lutetium,
B¹ is at least one element selected from zirconium, niobium, tantalum, tungsten, manganese, iron, cobalt, nickel, chromium, and magnesium, and
0≦x<1 and 0≦y<1.

20. The dielectric ceramic of claim 18, wherein the ferroelectric compound is BaTiO₃.

21. The dielectric ceramic of claim 18, further comprising a halide.

22. The dielectric ceramic of claim 21, wherein a content of the halide is about 0.001 weight percent to about 1 weight percent, based on a total weight of the dielectric ceramic.

23. The dielectric ceramic of claim 21, wherein the ferroelectric compound comprises a secondary particle, and the secondary particle comprises a plurality of primary particles, and
wherein the halide is disposed between adjacent primary particles.
